(19) United States
(12) Patent Application Publication
(10) Pub. No.: US 2016/0199880 A1
(43) Pub. Date: Jul. 14, 2016

(54) LAYERED MECHANICAL STRUCTURES FOR SECURITY APPLICATIONS

(71) Applicant: David L. GEORGE, San Jose, CA (US)

(72) Inventor: David L. George, San Jose, CA (US)

(21) Appl. No.: 14/914,432

(22) PCT Filed: Aug. 26, 2014
(86) PCT No.: PCT/US2014/052643

§ 371 Date: Feb. 25, 2016

Related U.S. Application Data
(60) Provisional application No. 61/870,127, filed on Aug. 26, 2013.
(60) Provisional application No. 62/018,195, filed on Jun. 27, 2014.

(51) Int. Cl. B05D 7/00

(52) U.S. Cl. CPC B05D 7/50

(57) ABSTRACT

A method and protocol is provided for constructing layered mechanical security structures having a structural outermost layer (10) and at least one interior ceramic layer (12) usually surrounding a core (14) to defeat attacks by thieves' tools. The method includes steps of: selecting and providing an outermost layer (10) selecting and providing an interior ceramic layer, whether continuous or intermittent; and constructing the security structure with the ceramic layer strategically placed to interact with the outermost layer to defeat and hinder attacks on the structure by typical thieves' tools. Examples of structures constructed in accordance with the method and protocol include a simple bar (2), a deluxe prison bar (4), padlock (6) with ceramic rod segments (90) forming intermittent ceramic layers (12), and a shackle (8) with fish-spline links (78). Additional metallic and ceramic layered components are also provided.

### APPLICATIONS

This is a non-provisional application. Priority is claimed from U.S. 61/870,127 filed 26 Aug. 2013, U.S. 62/018,195 filed 27 Jun. 2014, and PCT/US14/052643, all by the same current inventor.

### TECHNICAL FIELD

The present invention relates generally to security devices and structures and particularly for methods and protocols for constructing layered mechanical structures which are extremely resistant to cutting, breaking and tampering by criminal elements.

### BACKGROUND ART

Physical security structures, in the nature of locks, restraining bars, cords, posts, fences and other structures used to prevent theft and vandalism are a necessary part of human life and business, given the fallibilities of the species. The ingenuity of malefactors is legendary in that methods of defeating security often improve and are developed at least as rapidly as the structures themselves. Therefore, it requires continuing improvement in the structures developed to protect treasures and assets.

Of course, it is almost axiomatic that nothing is foolproof, or in many cases “burglar-proof”, so it often becomes a matter of trade-offs in cost, inconvenience for legitimate users, difficulty of defeat, and the amount of time it takes to defeat any security structure. In this light, anything that makes it more difficult or tedious for the attacker to overcome the security structure can result in great benefits in the protections of lives and property.

Over the years, many improvements have been made in construction materials have improved the efficacy of security structures. Improved alloys and the like have made it more difficult for thieves and the like to overcome them, but improved materials and sophistication in thieves' tools, such as rotary diamond cutters, laser cutters, hammer drills, and the like have kept pace. Consequently, new methods of approaching the problem are always desirable.

Accordingly, there is significant room for improvement and a need for better security structures, such as window bars and locks which provide a very high degree of resistance to cutting, breaking, or otherwise disabling attacks.

### DISCLOSURE OF INVENTION

Accordingly, it is an object of the present invention to provide a system for constructing layered and nested security elements of materials having different properties in order to thwart thieves and vandals.

Another object of the invention is to provide a method and protocol for layering mechanical security structures.

A further object of the present invention is to provide a pattern of construction for security structures which is adapted to hinder, slow and otherwise frustrate the improved tools and methods being used by malefactors.

Yet another object of the invention is to provide a structure protocol which frustrates heat cutting methods.

A further object of the present invention is to provide a security structure protocol to provide, in layers, components for structural integrity and hardness, abrasive cutting resistance, heat cutting resistance, heat and electromagnetic dissipation, and miscellaneous components.

Still another object of the invention is to provide a construction protocol which is adapted to a wide variety of types of structures as well as essentially unlimited variety of different shapes and sizes.

A still further object of the invention is to provide reactive resilient security impediments to critical components in order to prevent disabling by hammer drilling.

Yet another object of the present invention is to provide a method for utilizing rigid ceramic layer protection in bent or curved tubes or hollow bars.

Briefly, one preferred embodiment of the present invention is a method and protocol for constructing security structures. The method utilizes successive layering or interposing materials with different physical and conductive properties to defeat attempts to penetrate, break, cut or melt the structures. In its simplest application the method involves layering a ceramic material inside of a structural material, ordinarily with an inner core inside of the ceramic material. More extensive embodiments involve multiple layering and intermittent layering of the metallic and ceramic materials, and can include layers based on electromagnetic and thermally conductive materials as well. The method and protocol may be used in forming structures such as security bars, key locks and padlocks, security doors and the like.

An advantage of the present invention is that it provides for security structures which are highly resistant to breakage, mechanical and laser cutting, melting, and other failure conditions.

Another advantage of the invention is that it provides for security structures which impose significantly greater time and effort requirements in order to defeat the structure.

An additional advantage of the invention is that the use of intermittent layering, such as by provide discreet ceramic rods, can simplify construction and reduce costs.

Yet another advantage of the present invention is that utilizing discreet longitudinal segments of internal materials, especially discreet longitudinal ceramic links in conjunction with compression springs, results in lower potential for catastrophic crushing or breaking and significantly easier assembly as opposed to continuous tubes.

Still another advantage of the present invention is that the protocol is very flexible in application and can be readily adapted to different spatial restrictions and performance requirements.

A further advantage of the present invention is that it takes advantage of significant developments in the creation and cost-effectiveness of ceramic materials which may be incorporated into security structure.

Yet another advantage of the present invention is that the protocol facilitates incorporation of an endless variety of functional components in the protected core of tubular structures.

Another advantage is that the protocol of the present invention is that it utilizes divergent physical and conductive properties of layered materials to protect against different methods of destructive attacks against the structures.

Still another advantage of the present invention is that is it adaptable for use in a nearly endless variety of shapes and sizes of security structures.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings of some sample structures constructed in accordance with the method in which:

FIG. 1 is a perspective view of a simple security bar according to the invention, partially cut-away to illustrate interior components;

FIG. 2 is a cross sectional view of the bar of FIG. 1, taken along lines 2-2;

FIG. 3 is cross-sectional view of a security bar structure having multiple alternating layers and more detailed internal components;

FIG. 4A is a view of a typical padlock and FIG. 4B is a cross sectional view showing the interspersed ceramic materials which defeat cutting and drilling attacks;

FIG. 5 is a partially cut-away plan view of a portion of a nonlinear security bar, in the form of a shackle as used in a bicycle lock or padlock;

FIG. 6 is a cross-sectional view of a base for a shackle-type lock, including a cylinder guard; and

FIG. 7 is a side view of a deluxe version of a cylinder guard plug.

### BEST MODE FOR CARRYING OUT THE INVENTION

The present invention is method and protocol for constructing mechanical security structures which are highly resistant to disabling and tampering. The invention utilizes layering and nesting of divergent materials in order to thwart conventional methods used by thieves and vandals to disable or remove security barriers and fasteners from targets.

The construction protocol for improved security and protection structures involves interspersing ceramic materials which are resistant to cutting, sawing, laser cutting, hammer drilling, and thermal attacks inside of and layered with strong structural materials, ordinarily metallic. The ceramic “layers” may be continuous, arrayed in discrete abutting segments, or in some cases intermittent and situated in strategic locations to protect specific interior contents from destructive attempts to disable the structures. In the simplest forms the protocol utilizes a hard structural outer layer and a ceramic inner layer, while more complex applications involve multiple layers having different properties which impede different types of thieves' tools.

The method is adaptable to different situations and involves an initial determination step to establish the nature and parameters of the security structure involved, such as the size, shape, degree of security required, and the nature of the anticipated attacks on the structure. A prison bar, a bicycle lock, a padlock, and window bar for a shop may all require different approaches.

Once the parameters are determined, the next step involves selection of the material for and shape of the outer structural layer, including the interior shape and whether continuous, contiguous or intermittent ceramic layering is required.

The next step is to select the ceramic material and the nature of the layer structure, and to install the ceramic layer inside of the outer layer.

Optional steps include selecting and installing interior, special function components, and additional layers of metals and ceramics.

The protocol and method are best understood in view of example physical embodiments constructed in accordance with the invention.

Examples of security structures according to the invention are shown in the views of the drawing and are referred to as example embodiments I, II, III, IV, and V respectively. Example Embodiment I is a basic security bar 2 for windows, doors, and fences, or the like, and is one of the simplest structures. Embodiment II is a deluxe full-featured security bar 4, for use in special situations, such as in a prison, with additional features. Embodiment III is a typical padlock structure 6 using intermittent rather than complete layering. Example Embodiment IV is a cut resistant curved bar structure 8, such as for a lock shackle, showing the use of intermeshed ceramic fish-spline links. Example Embodiment V is a cylinder guard plug 9 specially adapted to prevent thieves from accessing and disabling key cylinders in locks.

In basic forms, the physical embodiments of devices constructed in accordance with the protocol and method of the invention utilizes a series of layers of divergent materials from the outside in, each layer having characteristics to counter/defeat typical techniques used by malefactors attempting to overcome the security aspects. The structures constructed according to the invention have a relatively hard and rigid structural outermost layer 10, with an intermediate layer 12 of a ceramic material and an inner core 14. In some embodiments the inner core 14 may actually be hollow, while in other instances, such as Embodiments 1 and II, it is filled with materials and/or components having special characteristics appropriate to the particular use. Other potential embodiments include enhancements such as additional intermediate layers, a heat conductor to syphon heat away from the area, case hardening of the outermost layer and other potential modifications which are uniquely suited to the particular application.

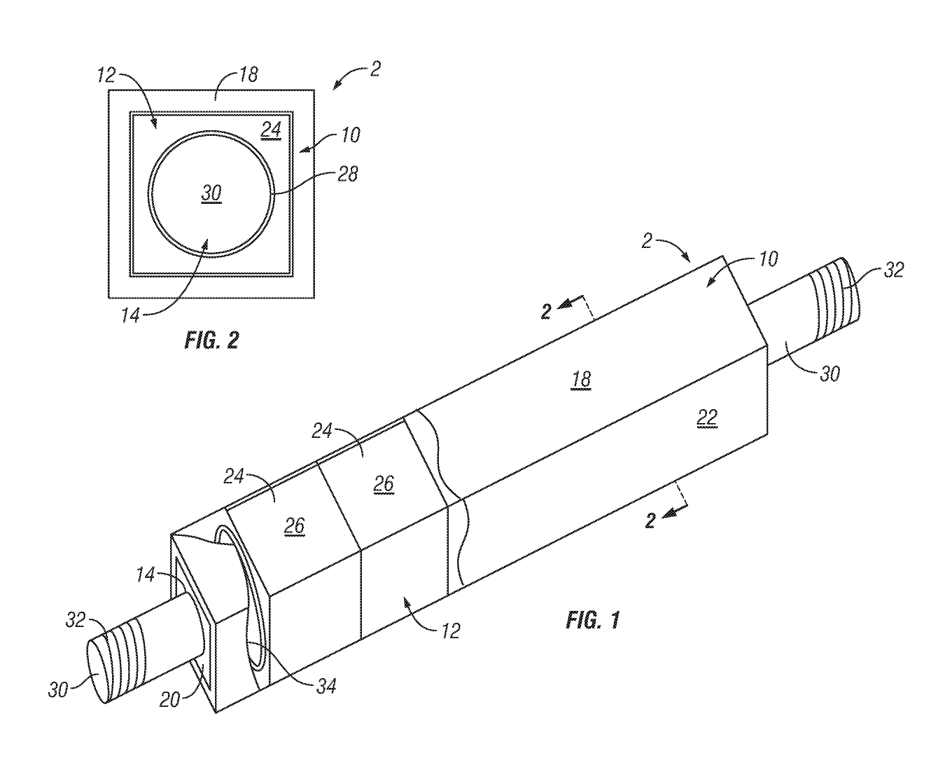

Referring now to FIGS. 1 and 2 (perspective and cross-sectional respectively), Example Embodiment I is illustrated to show the typical security bar 2 constructed according to the method and protocol of the present invention. The particular security bar 2 is adapted for use for windows and doors in moderately high danger areas, such as commercial establishments subject to break-ins and theft (e.g. jewelry stores). In this embodiment the outermost layer 10 is a rectangular tube 18 having a rectangular bore 20 extending longitudinally therethrough. The rectangular tube 18 element is a structural metallic material such as steel, wrought iron, aluminum (which foils diamond cutters by fouling the disks), or the like and is a rectangular shape to particularly resist ring cutter attack. In higher security versions, the rectangular tube 18 may be provided with a case hardened outer layer 22.

Nested within the rectangular bore 20 is a rectangular ceramic tube 24 (preferably formed in discreet segments 26 aligned end to end) having a circular bore 28, together forming the ceramic layer 12. Although the core 14 could be hollow and empty for some applications of this embodiment this particular version is provided with a center rod 30 which both resists bending and further has opposing threaded ends 32 to provide a “tail” which allows the structure to be screwed/bolted into place.

The use of discreet segments 26 for the ceramic layer 24 results in greater flexibility in assembly and construction than solid continuous ceramic tubing (which may be less expensive and easier to install). Since there is no requirement that the ceramic layer 24 provide significant structural support or any continuity for conductance (it actually acts as a thermal and electrical insulator), it is feasible to use discreet relatively short links or “slugs” (26) which can be aligned within the rectangular tube 18 (see cut-away view in FIG. 1). This type of structure also permits insertion of longitudinal spaces or small gaps in the ceramic layer 12 which can facilitate conductive communication between the outermost layer 10 and the core 14, when desirable. A compression spring 34 may also be provided at one or both ends (ordinarily held in place by adhesive or an end washer or cap—not shown) to apply compression force to the ceramic segments 26 such that, if one is crushed or broken by drilling or crushing, the adjacent segments 26 are forced inward to fill the gap and trap the drill bit or tool, thus inhibiting further attack.

This embodiment I is particularly effective in foiling thievery as the rectangular tube 18 provides strong structure, is resistant to bending and breaking, and is shaped to defeat common ring cutting techniques. The ceramic tube 24, preferably alumina or zirconia, is completely resistant to cutting if the outermost layer 10 is pierced and is also extremely effective against heat degradation, cold-shattering and laser cutting. The center rod 30 provides structural support to the ceramic tube 24 in order to prevent crushing and to minimize breakage and also serves to resist bending and crushing of the entire bar 2. In addition, as indicated above, the threaded ends 32 facilitate mounting. If the center rod 30 is omitted, or is not provided with tails 32, the bar 2 may also be welded into position or otherwise mechanically attached to the associated framework.

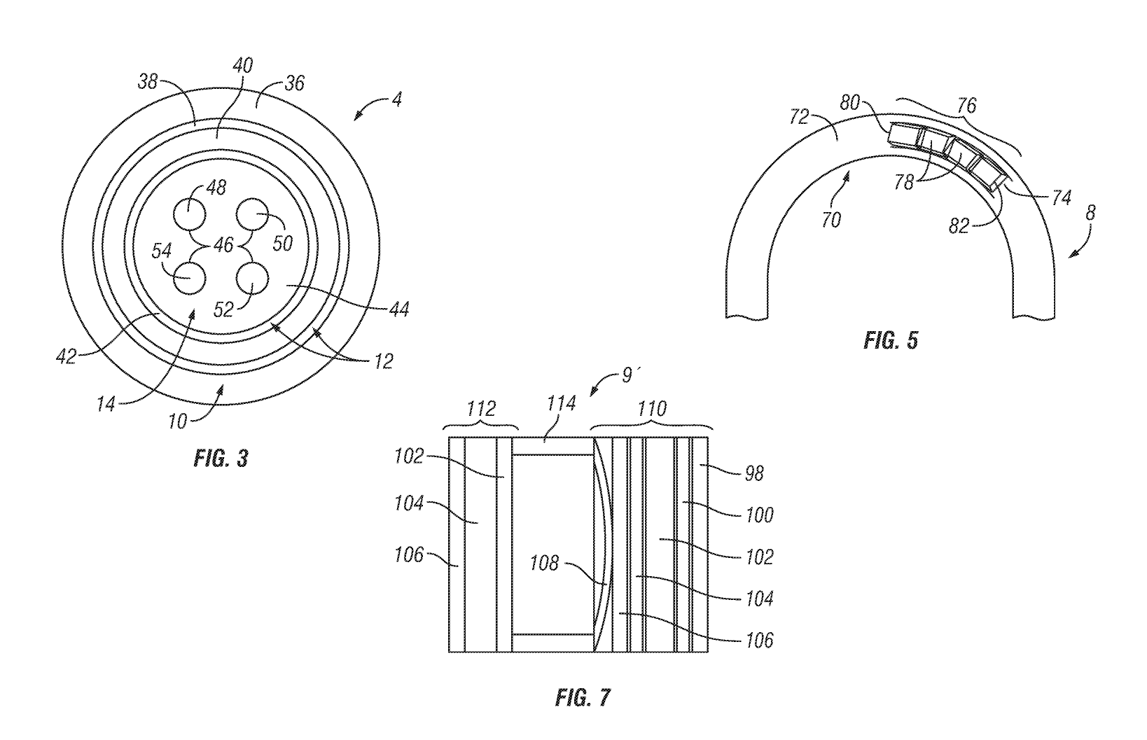

Example Embodiment II, shown in cross section in FIG. 3, is a specialized prison bar 4 adapted to have a deluxe structure for various purposes (the deluxe structure including additional elements which may also be incorporated in other embodiments). This embodiment II is especially adapted for high security applications, such as exist in prisons.

In the illustrated prison bar 4 the outermost layer 10 is a circular-cross-section metallic cylindrical tube 36 having a case-hardened surface 22. The case hardened surface 22 (preferably, the case-hardening being electromagnetically induced) is a further protection against cutting. Immediately within the cylindrical tube 36 is a first ceramic layer 38, similar in nature to those described earlier, but thinner. Nested within this is a conductive layer 40, preferably copper, to efficiently conduct heat away from (or, in the case of a super-cooled attack toward) the affected area. A second ceramic layer 42 lies immediately within the conductive layer 40 to insulate a multi-bore core 44 and the core components 16 and also to provide an additional anti-cut layer.

The multi-bore core 44 may be a softer metallic material or even a plastic foam or composite material, as desired for the particular purpose. For example, as shown in FIG. 3, the multi-bore core 44 can have any number of longitudinal mini-tubes 46 extending therethrough to contain various anti-theft and anti-destruction core components 16.

In the deluxe prison bar embodiment 4, the mini-tubes 46 include an anti-bend shorting structure 48 which includes a material adapted to shatter and short out a circuit to trigger an alarm in the event that the deluxe prison bar 4 is deformed out of shape and linear alignment. A second mini-tube 46 may include a sensitive audio pick-up 50 facilitating recording of sounds in the vicinity of the bar 4, which audio may be delivered to a central monitoring location for listening or recording. The audio pick-up 50 may be connected to the cylindrical tube 36 by insulated wiring, placed intermediate the discreet longitudinal segments 26 of the ceramic layers 40 and 44, to facilitate sound reception quality. A third mini-tube 46 may be a more conventional electromagnetic alarm 52 which is activated by heat, vibration or a combination of selected factors. The fourth mini-tube 46 in the prison bar 4 illustrated includes a marking fluid 54 (typically under pressure) which, when breached, spreads to tag the surroundings with indelible marks or scents which allow tracking of the person, clothing or equipment involved in the break.

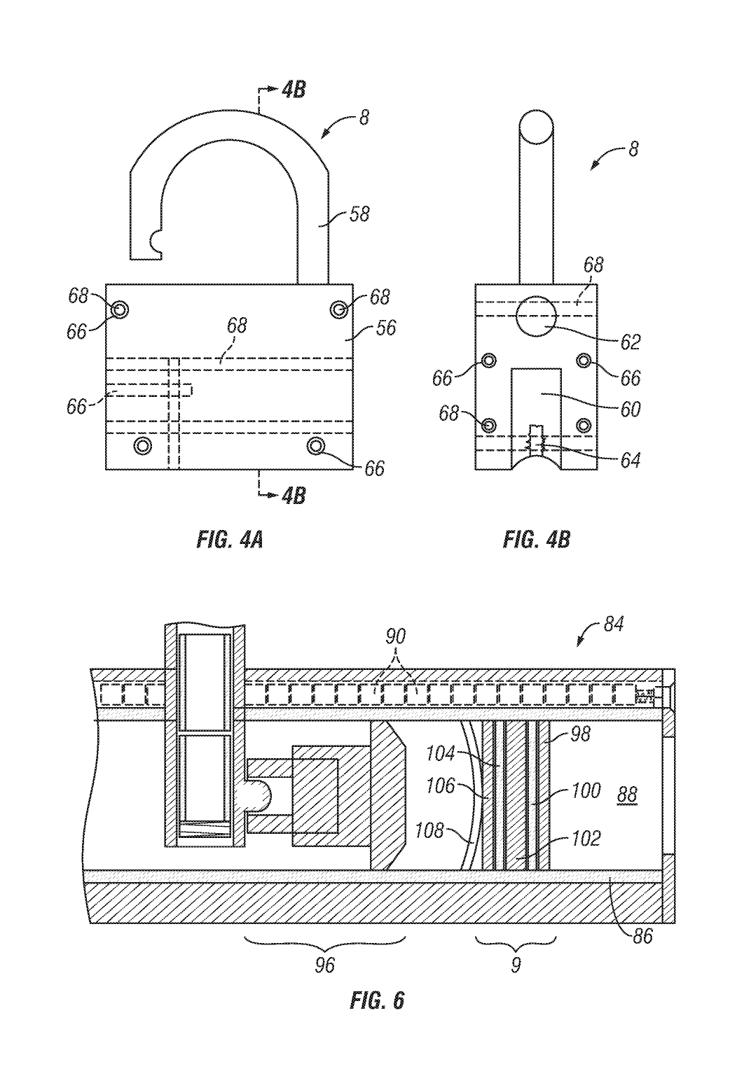

Example Embodiment III is a padlock 6, shown in FIGS. 4A (plan) and 4B (cross-sectional), which is provided with intermittent ceramic layering. The padlock 6 has a conventional metallic lock body 56 and a padlock shackle 58 (either conventional or cut-resistant) and some sort of conventional tumbler 60 activated by a unlock mechanism 62 (ordinarily either key or a combination dial). In this case, the padlock 6 is illustrated with a keyhole 64 into which a key may be inserted to rotate the tumbler 60 and release or capture the padlock shackle 62, when pushed onto the lock body 56. The lock body 56 in this embodiment 6 is provided with plug bores 66 with inserted ceramic plugs 68 to surround the tumbler 60 to resist drilling or other means of destroying the lock body 56.

The ceramic plugs 68 act in this case to defeat any cutting or drilling of the lock body 56 since ordinary cutting and drilling tools are unable to penetrate the ceramics, and instead foul the mechanisms. By interspersing the plug bores 66 and ceramic plugs 68 at strategic locations within the lock body 56, penetration into the tumbler 60 and unlock mechanism 62 is prevented and defeating the unlock mechanism 62 is made much more difficult. It is noted that the logistics of cutting the padlock shackle 58 in normal padlocks are often spatially very difficult in typical use and the padlock shackles 58 are typically, even in prior art structures, very resistant to cutting and breaking.

The illustration of FIG. 5 shows Embodiment IV, in a partially cut-away view, as a segment of a shackle 8, such as would be used in a larger padlock or bicycle lock. The shackle 8 includes an arc portion 70 which is curved. This embodiment 8 is provided to show that the security bars according to the present invention are not limited to linear constructions. This structure is described in more detail in the inventor's contemporaneous application for a Tamper Resistant Bicycle Lock (incorporated by reference).

The arc portion 70 is formed of a bent metallic cylinder 72 with a hollow center 74. An array 76 of ceramic fish-spline links 78 (also known as “fish” 78) is contained within the hollow center 74. The fish 78 are hollow cylindrical links tapered to have a convex end 80 and a concave end 82 and are placed in the array 76 such that a convex end 80 of one fish 78 will mesh with a concave end 82 of an adjacent fish. The fish 78 are preferably inserted into the hollow center 74 prior to bending the metallic cylinder 72 into the arc. The intermeshing of the fish 78 allows bending without breakage. This type of ceramic layer 12 maintains the protocol of an outermost layer 10 of a hard metallic material and an interior ceramic layer 12 to provide multiple deterrents to breakage, cutting and other methods of tampering.

Example embodiment V, illustrated in FIGS. 6 and 7, is a cylinder guard plug 9 structure particularly useful in larger lock instances where it is feasible to locate the actual key-activated lock cylinder within a tube and at a significant distance from the end of the tube. In the illustration of FIG. 6 a portion of the base 84 of an inventive bicycle lock structure (as described in more detail in the inventor's companion application for a Tamper Resistant Bicycle Lock, incorporated by reference herein) is shown in cross-sectional view, showing an embodiment of cylinder guard plug 9. A deluxe embodiment of the cylinder guard plug 9′ is shown in the side elevational view of FIG. 7.

Although the emphasis of this embodiment deals with the cylinder guard plug, the illustration of FIG. 6 also illustrates other applications of the inventive method, including a ceramic sleeve 84 lining the central bore 88 of the base to provide a ceramic interior layer. Also shown in phantom is an array of ceramic rod segments 90 longitudinally filling a corner bore 92 of the base 84. The corner bores 92 extend longitudinally through each corner of the base 84 but only one appears in this illustration. The ceramic rod segments 92 form an intermittent ceramic layer for the base 84, and particularly act to foul and defeat ring cutters utilized by cycle thieves.

The cylinder guard plug 9 is situated in the central bore 86 between the end aperture 94 and a lock cylinder 96 and acts to prevent direct attacks, such as by drilling (including hammer drilling), on the lock cylinder 96. As explained in the companion Bicycle Lock application the cylinder guard plug 9 can also be used to frustrate and defeat lock picking attempts.

The cylinder guard plug 9 is a series of layered planar elements (wafers, or in the case of a circular bore, disks) with each disk having distinct properties to combat attacks by thieves' tools. The disks are typically adhered together and longitudinally and rotationally secured in place. In the illustration of FIG. 6 the cylinder guard plug 9 includes in order from the end aperture inward; a cover disk 98 (preferably of stainless steel to prevent fracturing and inhibit drilling); a first ceramic disk 100 (to provide insulation and to defeat sawing and laser attacks); a central soft metal disk 102 (adapted to foul drill bits); a second ceramic disk 104; and a base disk 106 (preferably of hardened tool steel to be extremely resistant to breakage and to provide strong structural support). A reaction spring 108 (typically a Belleville washer) provides a reactive absorption and counter thrust to prevent breakdown of the plug 9 due to vibrational attacks, such as those from a hammer drill.

FIG. 7 illustrates a deluxe embodiment cylinder guard plug 9′ which utilizes a first plug 110 (identical in this embodiment with that shown in FIG. 6) and second plug 112 separated by a spacer tube 114. The second plug 112 utilizes the back portion of the first plug, with a soft metal disk 102, a second ceramic disk 104 and a tool steel base disk 106 to provide still further inhibition to longitudinal attacks on the lock cylinder 96. This embodiment utilizes the spacer disk 114 to provide a space in which the orientation of a key may be changed, allowing for offsetting keyhole structures which greatly frustrate lock picking attempts.

In each of the described example embodiments to be constructed in accordance with the inventive protocol, the functions are optimized by placement of ceramic materials intermediate or within structural materials. The ceramic materials provide significantly different physical and conductive properties than the typically metallic structural materials and thus present a much different challenge to the malefactors. The outermost layer 10 is typically hard and structurally strong, but may be subject to cutting by diamond cutters or the like. The ceramic layer 12, while it may be subject to breaking or crushing, is extremely resistant to physical cutting and sawing, laser cutting, and thermal attacks. This juxtapositioning of divergent materials allows the core 14 to be protected from all but the most determined and multi-pronged attacks.

As discussed above, the structural materials typically selected for the outermost layer 10 will be metallic, and may include, steel, stainless steel, wrought iron, aluminum, brass or any other material having significant structural strength and hardness.

Ceramic materials utilized in the ceramic layer 12, whether continuous or intermittent, may include: alumina; zirconium; corundum infused alumina, corundum infused zirconia; titanium diboride, graphene; transparent aluminum; and zirconia toughened alumina (zta). These materials can be cast, milled, extruded or otherwise formed into any desired shape.

Dimensions and shapes of the security structures are entirely dependent on the particular application and can vary widely. In particular, tubular structures can be in any form of hollow shape, including cross-sections in the form of ovals, non-square rectangles and other geometric configurations.

Many modifications to the above embodiments may be made without altering the nature of the invention. The dimensions and shapes of the components and the construction materials may be modified for particular circumstances.

While various embodiments have been described above, it should be understood that they have been presented by way of example only, and not as limitations.

### INDUSTRIAL APPLICABILITY

The method and protocol for constructing mechanical security structures of the present invention is intended for use in any sort of circumstances where burglary, theft and other forms of trespass are feared. It is especially suited for construction of security bars for windows, doors and cells, as well as posts for blocking entrances to driveways and the like. In addition, the protocol is very well adapted for use in locking structures such as padlocks, door and gate locks, vehicle (especially bicycle) locks, and utility meter locks.

The use of the protocol involving ceramic layers in or layered inside of structural layers results in requiring malefactors to invoke multi-pronged methods of attack in order to breach or defeat the security structure. In many cases, this will defeat the typical attempt and will, at the very least, require a great deal more time and effort on the part of the perpetrators. This may have the beneficial effect of causing the selection of easier targets. All of these factors result in greater protections of persons and property than are possible with security structures according to prior art methods and protocols.

Greater effectiveness in security is the cause of significant economic advantage. In addition, construction techniques utilizing intermittent layering or modular discreet longitudinal ceramic components can lessen material costs and/or simplify assembly.

For the above, and other, reasons, it is expected that the method and protocol for constructing mechanical security structures according to the present invention will have widespread industrial applicability. Therefore, it is expected that the commercial utility of the present invention will be extensive and long lasting.

While various embodiments have been described in the specification, it should be understood that they have been presented by way of example only, and not limitation. Thus, the breadth and scope of a preferred embodiment should not be limited by any of the described exemplary embodiments, but should be defined only in accordance with the following claims and their equivalents.

What is claimed is:

1. A method of constructing a mechanical security structure, in steps comprising:
selecting at least one outer layer of hard and strong structural material;
case-hardening the outermost surface of said outer layer;
selecting at least one ceramic material to form a ceramic layer; and
constructing the security structure with each said ceramic layer disposed to be interior to at least one said outer layer.

2. The method of claim 1 and further including:
a step, prior to said constructing step, of selecting a core component having properties different from said outermost layer and said ceramic layer; and
constructing the security structure with said core component lying interior to said ceramic layer.

3. The method of claim 1 wherein
said strong structural material is selected from the group including: steel, titanium; stainless steel; wrought iron; brass and aluminum,

4. The method of claim 1 wherein
said ceramic layer is selected from the group including: zirconium; alumina; corundum infused alumina; corundum infused zirconia; titanium diboride; graphene; transparent aluminum; and zirconia toughened alumina (zta).

5. The method of claim 1 wherein
said ceramic layer is continuous and is adapted to fit the interior shape of said outer layer.

6. The method of claim 1 wherein
said ceramic layer is formed in discreet segments placed in selected locations with or interior to said outer layer in order to form intermittent ceramic impediments to drilling, cutting, and like attacks aimed to disable critical interior components.

7. The method of claim 1 wherein
each said ceramic layer is formed in an array of discreet segments.

8. The method of claim 7 wherein
compression spring elements are placed in abutment with said array of discreet segments to force said segments together and, in the event of one segment being destroyed or reduced in size, to force an adjacent one of said segments into the gap created thereby.

9. A protocol for constructing mechanical security structures, comprising
an outermost layer formed of structural integrity and strength materials;
a ceramic layer, situated interior to at least some of said outermost layer, said ceramic layer formed of cut-resistant and electromagnetically and thermally insulating material;
a core, situated interior to said ceramic layer, having divergent and complementary physical and conductive properties from those of said exterior layer and said ceramic layer.

10. The protocol of claim 9, wherein
said ceramic layer is intermittent.

11. The protocol of claim 9, wherein
said outermost layer is in the form of an elongated tube having a center bore.

12. The protocol of claim 11, wherein
said ceramic layer is in the form of an array of discreet longitudinal segments each having an exterior adapted to closely fit inside said center bore and having a hollow interior to enclose said core.

13. A method of constructing non-linear security tubular structures, in steps comprising:
A) selecting a metallic tube having a hollow bore extending longitudinally therethrough;
B) selecting discreet ceramic links having an exterior shape generally conforming to the shape of said hollow bore and being adapted to longitudinally fit therein, said links each having a longitudinal bore and being adapted to longitudinally mesh with one another to allow a degree of longitudinal flexibility therebetween;
C) placing an array of said discreet ceramic links within said hollow bore; and
D) heating said metallic tube to a temperature to facilitate flexibility and bending said metallic tube said array into a desired shape.

14. The method of claim 13, wherein
prior to step C) an elongated flexible cable is placed through said longitudinal bores of a plurality of said discreet ceramic links to create said array; and
said flexible cable is used to draw said array of ceramic links into position within said metallic tube.

15. The method of claim 13, wherein
said discreet ceramic links are fish-spline links.

16. The method of claim 13, wherein
said heating in step D) is accomplished by electromagnetic induction.

17. The method of claim 14, wherein
core components are disposed in said longitudinal bore to further discourage breaching by thieves' tools by fouling such tools and/or by dispersing identifying materials to the perpetrator upon breach.
